(19) United States
(12) Patent Application Publication
(10) Pub. No.: US 2009/0168279 A1
(43) Pub. Date: Jul. 2, 2009

(54) ESD protection circuit with gate voltage raising circuit

(75) Inventor: Jung-Yen Kuo, Yunlin County (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/081,163

(22) Filed: Apr. 11, 2008

(30) Foreign Application Priority Data
Dec. 26, 2007 (TW) 096150269

(51) Int. Cl. H02H 9/04

(52) U.S. Cl. 361/56

(57) ABSTRACT

An ESD protection circuit with a gate voltage raising circuit is disclosed. The ESD protection circuit with a gate voltage raising circuit is used in a large size open drain circuit. A gate voltage raising circuit is used in the ESD protection circuit for raising the gate voltage of a NMOS.

### BACKGROUND OF THE INVENTION

1. Field of the Invention

The invention relates to an ESD protection circuit with a gate voltage raising circuit, and more particularly to an ESD protection circuit with a gate voltage raising circuit in a large size open drain circuit.

2. Description of the Related Art

For general circuit design, a circuit set is required in a circuit for preventing the circuit from damage by static electricity from human bodies or the environment, which would reduce operating lifespan of the circuit.

The circuit set is usually referred to an electrostatic discharge (ESD) protection circuit. In prior art, there are two types of ESD protection circuit designs.

1. Disposing a Ballast resistor in the ESD protection circuit, thus preventing a parasitic NMOS transistor from being irregularly turned on. Specifically, the disposition of the Ballast resistor decreases the irregular turned on condition of the parasitic NMOS.

2. Disposing an ESD clamp circuit between power lines for conducting a portion or all of the currents. FIG. 1 is a conventional output circuit with an ESD clamp circuit. Referring to FIG. 1, an output circuit 1 comprises an ESD clamp circuit 11 coupled between a power source VCC and a ground node 12. The output circuit 1 further comprises a PMOS 13, an NMOS 14, a parasitic diode 15, and an output terminal 16. A source of the PMOS transistor 13 is coupled to the voltage source VCC, and a drain thereof is coupled to the output terminal 16. A source of the NMOS 14 is coupled to the ground node 12, and a drain thereof is coupled to the output unit 16. The parasitic diode 15 is coupled to the voltage source VCC, and the output unit 16 is coupled to the parasitic diode 15. In a PS mode (positive source mode), the ESD clamp circuit 11 can conduct the electrostatic current to flow from the parasitic diode 15 sequentially to the power source VCC, the ESD clamp circuit 11, and the ground node 12, thereby decreasing damage from the electrostatic current.

For a large sized output circuit application, low on-state resistance (RDS ON) is usually required, however, a Ballast resistor can increase RDS ON. Assuming costs for a low RDSON requirement and a smaller layout size are considered usually, there is no Ballast resistor or a very small Ballast resistor in a large sized output circuit. Thus, a parasitic NMOS transistor of an ESD protection circuit of the example, will often be irregularly turned on. When the irregular turned-on condition occurs in a large sized open drain NMOS (ODMOS) transistor, the ESD problem of the output circuit becomes more serious. This is because an electrostatic discharge current has to pass through the NMOS transistor 14, rather than from the parasitic diode 15, due to not having a forward base diode, and sequentially to the voltage source VCC, the ESD clamp circuit 11, and the ground terminal 12 of FIG. 1. FIG. 2 is an output circuit with large sized open drain NMOSs (ODMOSs). Referring to FIG. 2, in an output circuit 2, a first parasitic capacitor 21 and a second parasitic capacitor 22 are used to provide voltage dividing, so that a first NMOS transistor 23 is normally turned on. In practice, however, the power source VCC is charged through the first parasitic capacitor 21 and a parasitic diode 25 when ESD occurs. When a capacitance between a voltage source VCC and a ground node is greater than the value of the first parasitic capacitor 21, the power source VCC is charged to an insufficiently high potential. Thus, making the potential of the gate of the first transistor 23 not high enough, and the resistance of the channel of the turned-on first NMOS transistor 23 too high, degrading the ESD protection. Additionally, when the second NMOS transistor 24 is in a turned-on state, the potential of the gate of the first transistor 23 is pulled to the ground terminal, and the ESD protection is further degraded.

### BRIEF SUMMARY OF THE INVENTION

An electrostatic discharge (ESD) protection circuit with a gate voltage raising circuit is provided. The ESD protection circuit with a gate voltage raising circuit, which is used in a large size open drain circuit, comprises a power source providing a voltage, a first P type metal oxide semiconductor is coupled to the power source, and a first N type metal oxide semiconductor is coupled to the first P type metal oxide semiconductor. Additionally, a parasitic diode is coupled to the first P type metal oxide semiconductor, a second N type metal oxide semiconductor is coupled to a drain of the first P type metal oxide semiconductor, and a first parasitic capacitor is coupled to the second N type metal oxide semiconductor. Meanwhile, a second parasitic capacitor is coupled to the first parasitic capacitor and the second N type metal oxide semiconductor, and a gate raising circuit is coupled to a gate and a source of the second N type metal oxide semiconductor. The gate raising circuit raises a gate voltage of the second N type metal oxide semiconductor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a conventional output circuit with an ESD clamp circuit;

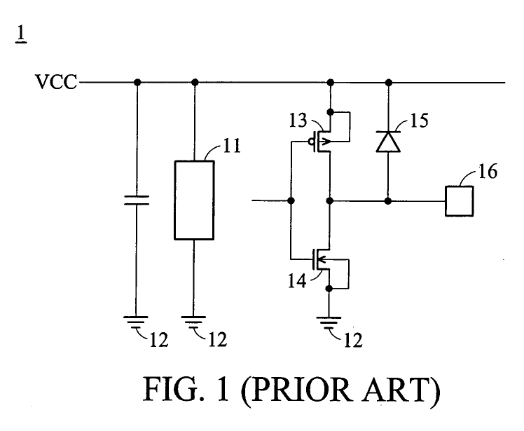

FIG. 2 shows an output circuit with large sized open drain NMOSs (ODMOSs); and

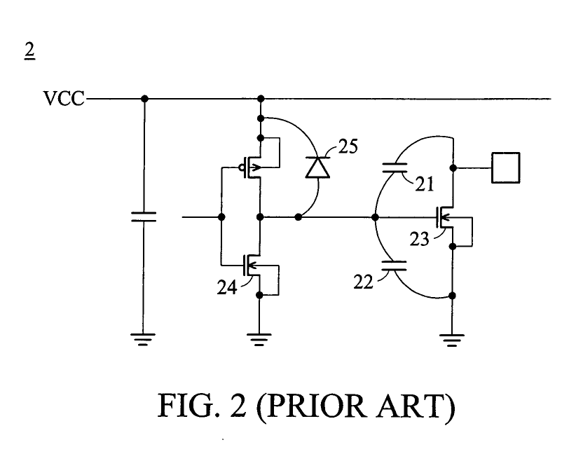

FIG. 3 illustrates the circuit diagram of an ESD protection circuit with a gate voltage raising circuit according to the embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

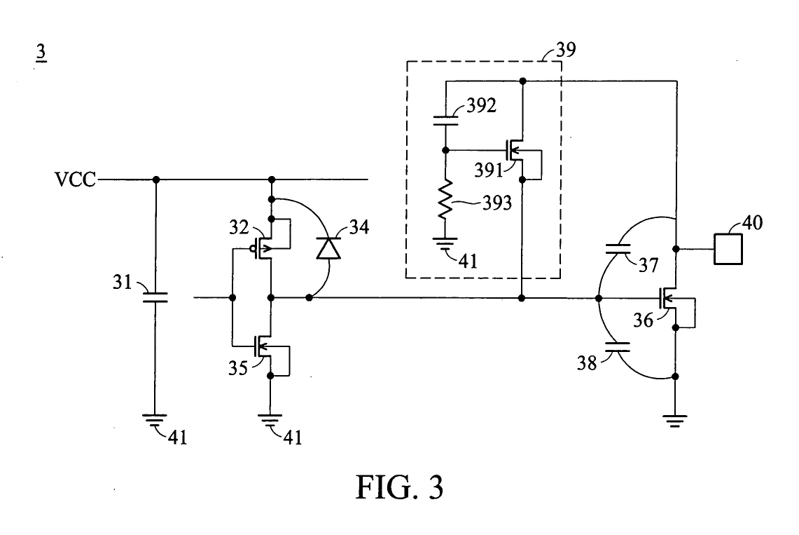

Please refer to FIG. 3. FIG. 3 illustrates the circuit diagram of an ESD protection circuit with a gate voltage raising circuit according to an embodiment of the invention. As shown in FIG. 3, an ESD protection circuit 3 with a gate voltage raising circuit comprises a power source VCC, a capacitor 31, a first PMOS 32, a first NMOS 35, a parasitic diode 34, a second NMOS 36, a first parasitic capacitor 37, a second parasitic capacitor 38, a gate voltage raising circuit 39, an output unit 40, and a ground node 41.

The capacitor 31 is coupled between the power source VCC and the ground node 41. The source of the first PMOS 32 is coupled to the power source VCC. The source of the first NMOS 35 is coupled to the source of the first PMOS 32. The gate of the first NMOS 35 is coupled to the gate of the first PMOS 32. The drain of the first NMOS 35 is coupled to the ground node 41. The parasitic diode 34 is coupled between the source and the drain of the first PMOS 32.

The gate of the second NMOS 36 is coupled to the drain of the first PMOS 32. The drain of the second NMOS 36 is coupled to the ground node 41. The source of the second NMOS 36 is coupled to the output unit 40. The first parasitic capacitor 37 and the second parasitic capacitor 38 are coupled in serial between the source and drain of the second NMOS 36.

The gate voltage raising circuit 39 coupled to the source of the second NMOS 36 comprises a third NMOS 391, a first capacitor 392, a first resistor 393, and a ground node 41. The first resistor 393 is coupled between the first capacitor 392 and the ground node 41. The other terminal of the first capacitor 392 is coupled to the source of the third NMOS 391. The drain of the third NMOS 391 is coupled to the gage of the second NMOS 36, and the gate of the third NMOS 391 is coupled to the first resistor 393.

The gate voltage raising circuit 39 raises the gate voltage of the second NMOS 36. Thus, the problems due to the power source VCC being charged to an insufficiently high potential, making the potential of the gate of the NMOS not high enough and the resistance of the channel of the turned-on NMOS too high, degrading the ESD protection, is avoided.

As discussed above, the embodiments of the invention mitigates the low gate voltage and irregularly turned-on problems of the NMOS, which improves ESD protection.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electrostatic discharge protection circuit with a gate voltage raising circuit, used in a large size open drain circuit, comprising:
a power source providing a voltage;
a first P type metal oxide semiconductor coupled to the power source;
a first N type metal oxide semiconductor coupled to the first P type metal oxide semiconductor;
a parasitic diode coupled to the first P type metal oxide semiconductor;
a second N type metal oxide semiconductor coupled to a drain of the first P type metal oxide semiconductor;
a first parasitic capacitor coupled to the second N type metal oxide semiconductor;
a second parasitic capacitor coupled to the first parasitic capacitor and the second N type metal oxide semiconductor; and
a gate raising circuit coupled to a gate and a source of the second N type metal oxide semiconductor; wherein the gate raising circuit raises a gate voltage of the second N type metal oxide semiconductor.

2. The electrostatic discharge protection circuit with a gate voltage raising circuit as claimed in claim 1, wherein the gate raising circuit comprises a third N type metal oxide semiconductor, a first capacitor, a first resistor, and a ground node.

3. The electrostatic discharge protection circuit with a gate voltage raising circuit as claimed in claim 2, wherein the first capacitor is coupled to a source of the third N type metal oxide semiconductor, and the first resistor is coupled to the first capacitor and the ground node.
